(19) United States
(12) Patent Application Publication
(10) Pub. No.: US 2020/0239980 A1
(43) Pub. Date: Jul. 30, 2020

(54) DC ARC FURNACE FOR WASTE MELTING AND GASIFICATION

(71) Applicant: PYROGENESIS CANADA INC., Montreal (CA)

(72) Inventors: Pierre CARABIN, Montreal (CA); William KREKLEWETZ, Pointe-Claire (CA); Ali SHAHVERDI, Verdun (CA); Hugo FORTIN-BLANCHETTE, Saint-Hubert (CA)

(21) Appl. No.: 16/755,106

(22) PCT Filed: Oct. 15, 2018
(86) PCT No.: PCT/CA2018/000194

§ 371 Date: Apr. 9, 2020

Related U.S. Application Data
(60) Provisional application No. 62/572,412, filed on Oct. 13, 2017.

(51) Int. Cl. C22B 9/22; H05B 7/18; F27D 7/06; F27D 11/10; F27D 17/00; C10J 3/72; C10J 3/74

(52) U.S. Cl. CPC C22B 9/226; H05B 7/18; F27D 7/06; F27D 11/10; F27B 2014/0837; C10J 3/723; C10J 3/74; F23G 2204/201; F27D 17/003

(57) ABSTRACT

An apparatus for the gasification and vitrification of waste comprises a plasma arc furnace provided with two movable graphite electrodes. The furnace includes an air-cooled bottom electrode adapted for transferring the current through a slag melt. The furnace is entirely sealed and is also provided with gas tight electrode seals adapted to control reducing conditions inside the furnace. An electrical circuit is further provided, which is adapted for switching from transferred io non-transferred modes of heating, thereby allowing the furnace to be restarted in case of slag freezing.

### CROSS REFERENCE TO RELATED APPLICATIONS

This Application claims priority on U.S. Provisional Application No. 62/572,412, now pending, filed on Oct. 13, 2017, which is herein incorporated by reference.

### FIELD

The present subject matter relates to a direct current (DC) arc furnace used for waste vitrification and gasification, and more particularly to a method and apparatus for igniting and restarting DC arcs on non-conductive mixtures of metal oxides, such as those found in waste, and for providing complete melting.

### BACKGROUND

Plasma arc furnaces have been proposed for converting waste into energy and construction materials. More specifically, plasma furnaces have been used for melting inorganic materials and gasifying organic compounds in waste. Plasma furnaces offer several advantages over conventional incineration technologies, such as the ability to treat materials independent of their inherent heating value, their ability to vitrify the inorganic components of waste into an inert slag, and their ability to convert the organic components of waste into a combustible gas composed mainly of hydrogen and carbon monoxide called syngas, thereby allowing for the production of clean energy from waste. Several apparatuses and methods relating to the use of plasma furnaces for converting waste into molten slag and energy have been proposed.

For example, U.S. Pat. No. 5,280,757, which is entitled “Municipal Solid Waste Disposal Process” and issued in the names of Carter et al. on Jan. 25, 1994, discloses an apparatus that uses a non-transferred plasma torch to gasify municipal solid waste, coal, wood and peat into a medium quality gas and an inert monolithic slag having substantially lower toxic element leachability.

Similarly, U.S. Pat. No. 4,998,486, which is entitled “Process and Apparatus for Treatment of Excavated Landfill Material in a Plasma Fired Cupola” and issued in the names of Dighe et al. on Mar. 12, 1991, discloses an apparatus that also uses a non-transferred plasma torch to process hazardous waste in a cupola furnace, whereby hazardous materials such as PCBs are volatilized and consumed in an afterburner, while hazardous materials containing heavy metals are molten within the cupola and converted to a non-leachable solid product.

However, the use of non-transferred plasma torches to gasify and vitrify waste and other materials offers several drawbacks. Because of the extreme temperatures of the plasma gas, non-transferred plasma torches need to be water cooled. The use of water cooling in the torch reduces the heat conversion efficiency of the torch. In many cases, energy loss to the cooling water can reach between 15% and 35% of the electrical energy input to the torch. In addition, because the torch often needs to protrude through thick refractory lined walls, additional heat losses occur from the water-cooled body of the torch to such refractory walls. Finally, with the torch operating in the non-transferred mode, a large part of the plasma gas escapes to the furnace off-gas instead of treating the solid material in the furnace. Consequently, the net efficiency of heat is often less than 50%.

Another drawback of the water-cooled non-transferred torch is the risk of water leaks. In some cases, torch water leaks can lead to steam explosions when the high-pressure water escaping from a failing torch hits the superheated molten slag inside the furnace (Beaudet et al, 2000).

It has therefore been proposed to use non water-cooled graphite arc furnaces for the purpose of gasifying and vitrifying waste. Graphite arc furnaces offer several advantages compared to plasma furnaces that use plasma torches. Not being water-cooled, the graphite electrodes are inherently safe, compared to furnaces that use torches that can leak. Not being water-cooled, the graphite electrodes are also much more efficient than water-cooled torches, attaining close to 100% efficiency in the transfer of energy from the electric arcs to the mass of waste material to be treated. Graphite arc furnaces can be of the alternating current (AC) or direct current (DC) type.

Conventional three-phase AC arc furnaces cannot usually be used for the purpose of waste gasification and vitrification. Typically, AC furnaces are of an open top design, thereby limiting the ability of controlling the quality of the syngas produced because of large air ingression into the furnace. Three-phase AC furnaces cannot easily transfer electrical current to the nonconductive material such as cold waste glass or combustion ash residues. Several methods have been proposed to alleviate this problem, and, in particular, some DC furnaces offer methods of switching from a non-transferred arc to a transferred arc mode of operation, such as in U.S. Pat. No. 5,958,264, which is entitled “Plasma Gasification and Vitrification of Ashes” and issued in the names of Tsantrizos et al. on Sep. 28, 1999. Other furnaces can operate both in AC and DC modes of operation, wherein the AC is used for Joule heating of the slag and the DC arcs are used to produce electric arcs above the melt, such as in U.S. Pat. No. 5,666,891, which is entitled “ARC Plasma-Melter Electro Conversion System for Waste Treatment and Resource Recovery” and issued in the names of Titus et al. on Sep. 16, 1997.

In aforementioned U.S. Pat. No. 5,666,891, there is described a waste-to-energy conversion system and apparatus for the purpose of converting a wide range of waste streams into useful gas and a stable, non leachable solid product. In one embodiments, the furnace uses combined AC Joule heating of the molten inorganic fraction of the waste with DC plasma arcs in the gas phase. In this system, the plasma arc furnace and joule-heated melter are formed as a completely integrated unit having circuit arrangements for the simultaneous operation of both the arc plasma and the joule-heated portions of the unit without interference from one another. However, this design is complex, necessitating multiple power supplies and complex circuit arrangements. There is also a risk that the AC electrodes could freeze in the slag, making it very difficult to restart the furnace.

For example, aforementioned U.S. Pat. No. 5,958,264 discloses an apparatus for the gasification and vitrification of ashes, such as those produced in a hog fuel boiler. The apparatus is a shaft furnace using two or three tiltable electrodes that can operate in a horizontal or vertical position. By changing the position of the electrode from horizontal to vertical, the arc can be changed from non-transferred to transferred mode. However, this design has several drawbacks. For instance, the electrode pass-through is not perfectly sealed and can lead to uncontrolled gasification inside the furnace. Also, the heating of the slag in non-transferred mode is very inefficient and the slag could freeze: if its level is too high, the plasma heat cannot be transferred efficiently to the lower layers. Furthermore, the arc voltage is very unstable, being dependent on the varying composition of the syngas inside the furnace. Also, because the electrodes are at an angle, they can create an arc jet directed at the refractory, which can cause excessive refractory wear.

Therefore, it would be desirable to provide an apparatus for gasification and vitrification of waste, which ensures a substantially complete melting of the slag, substantially avoids freezing of the slag, and improves energy transfer from the plasma arcs to the waste being processed.

### SUMMARY

It would thus be desirable to provide a novel apparatus for gasification and vitrification of waste.

The embodiments described herein provide in one aspect an apparatus for the gasification and vitrification of waste, comprising a plasma arc furnace provided with two movable graphite electrodes, the furnace including an air-cooled bottom electrode adapted for transferring the current all through a slag melt, the furnace being sealed at a junction of a spool and a crucible thereof, and being further provided with gas tight electrode seals adapted to control reducing conditions inside the furnace.

Also, the embodiments described herein provide in another aspect a plasma arc furnace, comprising a spool and a crucible, a pair of movable electrodes, e.g. made of graphite, an air-cooled bottom electrode adapted for transferring current all through a slag melt, the furnace being sealed at a junction of the spool and the crucible thereof, and being further provided with gas tight electrode seals adapted to control reducing conditions inside the furnace.

Furthermore, the embodiments described herein provide in another aspect a DC arc furnace, comprising a spool and a crucible, a pair of movable electrodes, e.g. made of graphite, an air-cooled bottom electrode adapted for transferring current all through a slag melt, the furnace being sealed at a junction of the spool and the crucible thereof, and being further provided with gas tight electrode seals adapted to control reducing conditions inside the furnace.

Specifically, an electrical circuit is further provided, the electrical circuit being adapted for switching from transferred to non-transferred mode of heating, thereby allowing for the restarting of the furnace in case of slag freezing.

### BRIEF DESCRIPTION OF THE DRAWINGS

For a better understanding of the embodiments described herein and to show more clearly how they may be carried into effect, reference will now be made, by way of example only, to the accompanying drawings, which show at least one exemplary embodiment, and in which:

FIG. 1 is a general schematic view showing the principle of operation of a furnace in accordance with an exemplary embodiment;

FIG. 2 is a vertical cross-sectional view of a more detailed furnace in accordance with an exemplary embodiment, which is based on the furnace of FIG. 1;

FIG. 3 is a detailed vertical cross-sectional view of an electrode seal in accordance with an exemplary embodiment;

FIG. 4 is a vertical cross-sectional view showing specifically details of a bottom anode in accordance with an exemplary embodiment; and

FIGS. 5a and 5b are schematic views of the electrical circuit of the furnace for two modes of operation, in accordance with an exemplary embodiment.

### DESCRIPTION OF VARIOUS EMBODIMENTS

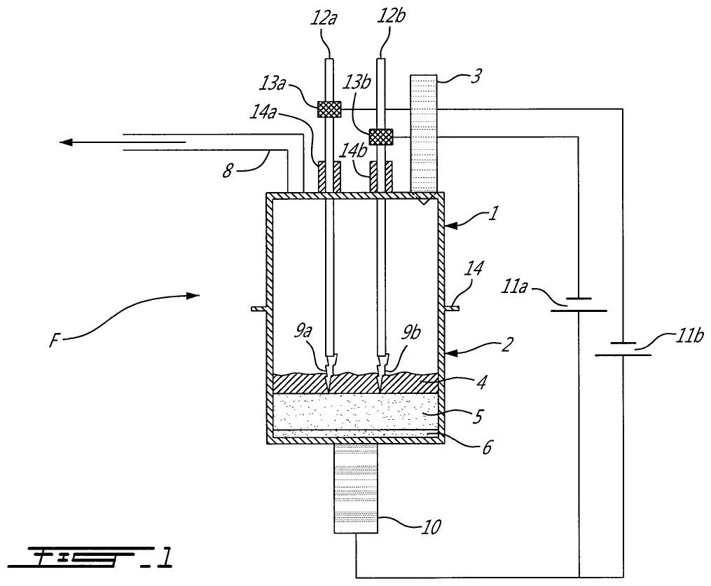

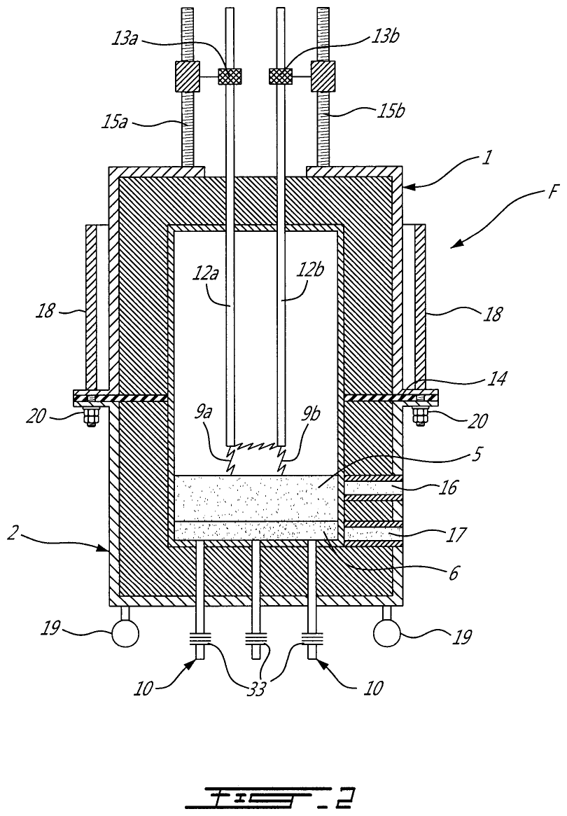

With reference to FIGS. 1 and 2, an embodiment is shown wherein a DC arc furnace F comprises two parts: a spool 1 and a crucible 2, which are both refractory-lined so as to operate at high temperatures. The refractory used in the crucible 2 should be compatible with molten silicates type materials and can be made of high alumina or alumina chrome material. The refractory used in the spool 1 should be compatible with potentially corrosive high temperature gases and can be made of a high alumina or alumina-silica material. It is noted that the components illustrated in FIG. 2 are part of the furnace F of FIG. 1.

In normal operation, the material to be gasified and melted is introduced continuously through one or multiple feed ports 3 located at the top of the spool 1. The material being treated accumulates in the crucible 2, creating a top layer thereat of partially treated waste 4. The high temperatures in the furnace crucible 2 (typically more than 1400° C.) and the injection of gasification air, oxygen and/or steam separate the organic from the inorganic fraction of the waste. The inorganic fraction melts into a liquid slag layer 5 floating on top of a molten metal layer 6. The organic fraction is converted into a synthesis gas consisting mainly of carbon monoxide and hydrogen or a combustion consisting mainly of carbon dioxide and water vapour. The gas exits the furnace through an exhaust port 8.

An outside shell of the crucible 2 can be fitted with fins and forced air cooling, in order to minimize refractory erosion. The purpose of the forced air cooling is to move the slag freeze line well inside the layer of the liquid slag layer 5 and away from the refractory lining.

A pair of electric arcs 9a and 9b are maintained inside the furnace F. The arcs 9a and 9b are partially submerged in the mass of partially treated waste 4 and are transferred to the liquid slag layer 5. The current passes through the molten metal layer 6 and a bottom anode 10.

Two power supplies 11a and 11b are used to provide the electric current to sustain the electric arcs 9a and 9b. It is noted that all of the components shown in FIG. 1 are part of the furnace F, except for the power supplies 11a and 11b. The power supplies 11a and 11b are direct current (DC) units, e.g. of the current-controlled type. The current is fed to a pair of electrodes 12a and 12b, which are typically made of graphite. When properly sized for its current carrying capacity (16 to 32 A/cm2), the graphite does not overheat and does not need to be water cooled. The use of graphite electrodes 12a and 12b therefore resolves the problem of water cooling in plasma furnaces and the risk of steam explosion is avoided. The use of graphite electrodes 12a and 12b and free burning arcs 9a and 9b inside the furnace F also ensures a very high energy transfer efficiency, as no energy is lost to water cooling. The graphite electrodes 12a and 12b used can be found on the market from a few inches in diameter to much larger sizes (for example, 32 inches). The electrodes 12a and 12b are commonly found on the market and are supplied by companies such as SGL Carbon and Graftech/UCAR.

The use of graphite electrodes 12a and 12b simplifies the scale up process, as it is possible to increase the size of the electrodes easily. The current carrying capacity of the electrodes 12a and 12b is directly proportional to the section of the electrode or proportional to the square of the diameter of the electrode. The largest electrodes have a current carrying capacity of 140 kA or more, making them suitable for waste treatment applications at a large scale. For example, a furnace using two 6-inch electrodes can be used for the treatment of 10 tons per day of municipal solid waste, and will require 400 kW of power and operate at 2000 Amps. On this basis, two 32-inch electrodes would allow to treat 700 tons per day of waste in a single furnace. By contrast, by using non-transferred arc plasma torches, multiple torches will need to be used to obtain the same energy. For example, to achieve the same amount of energy transfer using 1 MW gross power torches with 75% efficiency, 37 individual plasma torches would be required.

Referring to FIG. 2, current is fed to the two electrodes 12a and 12b using a pair of electrode clamps 13a and 13b, respectively. The commercially available electrodes include a mechanism to screw them together using connecting pins. The connecting pins are threaded connectors that allow to connect two lengths of electrodes together. During normal operation of the furnace F, the graphite is gradually eroded by the arcs 9a/9b. The electrodes 12a and 12b are mounted on respective movement mechanisms 15a and 15b, which slowly move the electrodes 12a and 12b down in the furnace F as they erode. The movement mechanisms 15a and 15b provide an up/down feature that also permits the adjustment of the arc voltage. The arc voltage is directly proportional to the arc length, which is proportional to the distance between the tip of each electrode 12a and 12b and the top of the liquid slag layer 5. Once a length of electrode 12a/12b has been completely eroded, a new length can be screwed in from the outside of the furnace F, using the aforementioned connecting pins.

In order to adjust the plasma power, the voltage is maintained constant by adjusting the height of the electrodes 12a and 12b. A current setpoint is given to the power supplies 11a and 11b which have their own current controls. The power is a function of voltage times current. The temperature of the liquid slag layer 5 can be controlled by adjusting the plasma power. The plasma power can also be used to compensate for the energy requirements of endothermic reactions, such as pyrolysis reactions.

The spool 1 and crucible 2 are made of two distinct parts. The crucible 2, which can be detached from the spool 1, is provided with wheels 19 and can be lowered onto a track, to be rolled away for refractory maintenance. Once maintenance is completed, the crucible 2 is put back in place and can be moved up and maintained into position using a series of tie rods 18. A series of nuts 20 on each tie rod 18 are used to lift and maintain the crucible 2 in place.

Two tap holes 16 and 17 are provided to extract respectively excess liquid slag and liquid metal from the respective liquid slag layer 5 and molten metal layer 6 of the furnace F. As more waste is fed to the furnace F, the molten inorganic material amalgamates into the existing liquid slag layer 5. With time, and with continuous feeding of waste material into the furnace F, the height of the liquid slag layer 5 will increase. Non oxidized metal which is denser than the oxidized fraction will accumulate below the slag layer 5 in the liquid molten metal layer 6. The upper tap hole 16 is thus used to extract the oxidized slag from the liquid slag layer 5, while the bottom tap hole 17 is used to extract metal from the molten metal 6.

Referring again to FIG. 1, the furnace F is completely enclosed, to prevent any unwanted ingression of air into the furnace F. Oxygen from the air would cause excessive combustion of the waste in the furnace and would lower the quality of the syngas produced. There is provided a seal 14 between the spool 1 and the crucible 2. This seal 14 can be made of graphite or high temperature refractory paper. There are provided two electrode seals 14a and 14b that prevent air ingression from around the electrodes 12a and 12b.

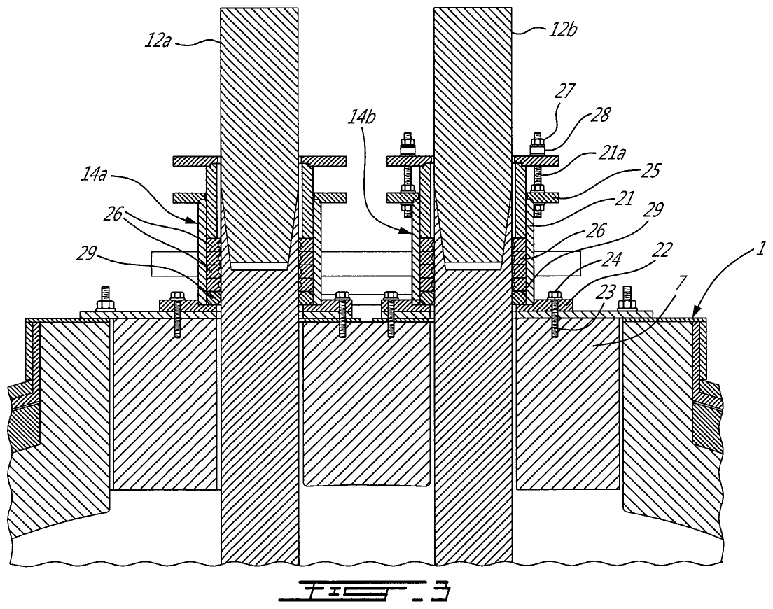

A detailed view of the electrode seals 14a and 14b is provided in FIG. 3. Each electrode 12a/12b passes through a metal tube 21. There is a bottom plate 22 welded to the tube 21, which allows to mount the tube 21 to the top of the refractory 7 of the spool 1, via threaded rods 23 that are cast in the refractory 7 and nuts 24, which are used to hold the tube 21 with its plate 22 in place. Attaching the electrode seal tube 21 to the refractory 7 and not to the steel shell of the spool 1 insulates the electrodes 12a and 12b from each other and from the shell.

A top flange 25 is welded to the tube 21 and is used to attach a second free moving tube 21a with a set of threaded rod, nuts and washers, as detailed hereinbelow. Several layers of graphite rope 26 provided on top of a refractory rope 29 are used to seal the gap between the outer tube 21 and the electrode 12a/12b. As the seal gets eroded from the movement of the electrode 12a/12b, the seal can be tightened around the electrode 12a/12b by tightening four nuts 27 (two such nuts 27 being herein shown) around the electrode 12a/12b. A set of beveled washers 28 are used to prevent the nuts 27 from loosening up during operation. The use of the refractory rope 29 avoids the use of any water cooling around the seal.

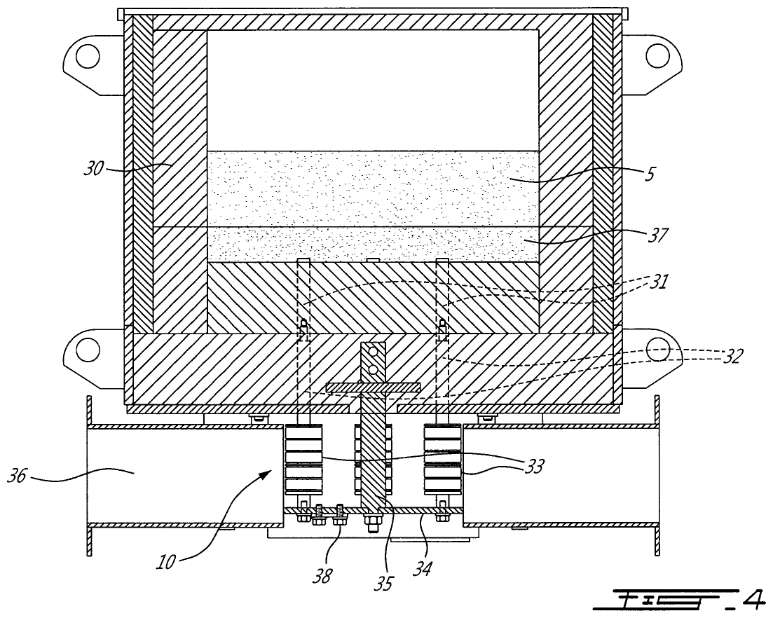

As illustrated in FIG. 4, the bottom anode 10 provides a current return path for the electricity used to power the electric arcs 9a and 9b. The bottom anode 10 is air cooled, to avoid any risk of contact between the liquid slag and water in case of crucible failure and therefore to prevent steam explosions. The design is exempt from the use of cooling water.

The bottom anode 10 is provided with one or more electrodes which are conductive rods 31 made of metal or graphite that is embedded in the refractory lining 30 of the crucible 2. The number and cross section of the electrodes are sized as a function of their current carrying capacity requirements. The conductive rods 31 can be either in direct contact with the liquid slag layer 5 or be in contact with a conductive plate 37. The conductive plate 37 can be made of graphite or a metal such as iron or steel. In the case of a metal plate 37, it will normally melt during furnace operation. In order to ensure that the electrodes themselves do not melt, they are externally cooled using cooling fins 33.

The conductive rods 31 are connected to copper rods 32. The copper rods 32 are mounted to the conductive rods 31, and herein in an aligned relationship. The copper rods 32 have a machined male thread while the conductive rods 31 have a machined female thread for allowing the conductive rods 31 and the copper rods 32 to be threadably assembled together. Shoulders on the rods 31 and 32 ensure a good electrical contact between the two parts. Copper is used for the rods 32 in order to provide high electrical and thermal conductivity, while a high melting point metal or graphite is used for the conductive rods 31 so as to minimize the electrode melting effect close to the liquid slag layer 5.

The copper rods 32 are connected together with a copper plate 34. The copper plate 34 is held to the crucible 2 by a tee-shaped metallic support 35, embedded in the refractory of the crucible 2 . The copper plate 34 is bolted to the tee-shaped support 35. The fact that the support 35 is embedded in the refractory with no contact to the metal shell ensures that the entire bottom anode 10 remains electrically floating and not at the same potential as the crucible shell which is grounded.

The copper rods 32 are connected in parallel. The copper plate 34 is connected to electrical DC cables through lugs 38. The cooling fins 33, which are made of copper or aluminum, are used to maximize the heat transfer surface to the copper rods 32.

Forced air cooling is used to cool the fins 33. A plenum 36 is provided to force air circulation around the fins 33. A low-pressure air blower (not shown) is used to feed the cooling air to the plenum 36. The plenum 36 is held to the bottom of the crucible 2 by a set of bolts that are threaded into the crucible shell. The plenum 36 can be provided with baffles (not shown) to ensure optimal air distribution to the cooling fins 33.

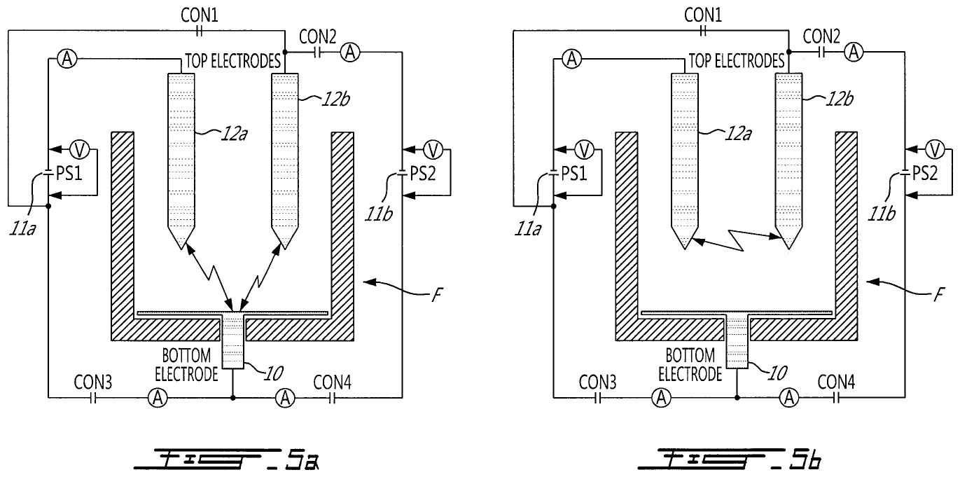

As illustrated in FIGS. 5a and 5b, there is provided a circuit and method to switch between transferred and non-transferred arc mode of operation in the furnace.

The transferred mode of operation is illustrated in FIG. 5a. In the transferred mode of operation, the current is transferred between each cathode 12a and 12b to the bottom anode 10. Current for the left circuit is provided by a power supply PS1 11a. Contactor CON3 is closed while contactor CON1 remains open. Current for the right circuit is provided by a power supply PS2 11b. Contactors CON2 and CON4 are closed.

The non-transferred mode of operation is illustrated in FIG. 5b. In the non-transferred mode of operation, the current is transferred between cathode 12a and electrode 12b which acts as a cathode. One single power supply PS1 11a is used to drive the arc. In this case, contactors CON2, CON3 and CON4 are open, while contactor CON1 is closed.

There is also provided a method for restarting the furnace F in case of process upsets and for switching between non-transferred and transferred modes of operation. In the case of process upset and that the liquid slag layer 5 is frozen, the transferred mode to the bottom anode 10 will not be possible as the frozen slag will not conduct electricity. In that case, it is possible to feed electrically conductive material such as graphite powder or metal shavings between the electrodes 12a and 12b. The electrodes 12a and 12b are lowered to touch this conductive material. Once a circuit has been initiated, it is possible to slowly move up the electrodes 12a and 12b and create an arc therebetween, using the non-transferred mode of operation. It is desirable to quickly switch to the transferred mode of operation as this mode is more efficient in terms of energy transfer to the mass of waste being treated. In that case, referring to FIG. 5b, the contactor CON3 is closed and current passing through the wire next to the contactor CON3 is monitored using an ammeter. Once current starts passing through this wire, CON1 is opened, forcing the transfer and the passing of all electricity through the bottom electrode 10. Once the transferred arc mode has been stabilized, the power supply PS2 11b is powered on and the contactors CON2 and CON4 are closed, returning to normal transferred mode of operation.

In order to stabilize the arc in the transferred arc mode of operation, it is possible to use hollow electrodes and inject a plasma forming gas in the electrodes. This gas is preferably a monoatomic gas, such as argon or helium, or a mixture of monoatomic gases.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the embodiments and non-limiting, and it will be understood by persons skilled in the art that other variants and modifications may be made without departing from the scope of the embodiments as defined in the claims appended hereto.

### REFERENCES

[1] G. O. Carter and A. Tsangaris, “Municipal Solid Waste Disposal Process”, U.S. Pat. No. 5,280,757, Jan. 25, 1994.
[2] S. V. Dighe, R. F. Taylor, R. J. Steffen and M. Rohaus, “Process and Apparatus for Treatment of Excavated Landfill material in a Plasma Fired Cupola”, U.S. Pat. No. 4,998,486, Mar. 12, 1991
[3] R. A. Beaudet et al., “Evaluation of Demonstration Test Results of Alternative Technologies for Demilitarization of Assembled Chemical Weapons—A Supplemental Review, Committee on Review and Evaluation of Alternative Technologies for Demilitarization of Assembled Chemical Weapons”, National Research Council, (2000)
[4] P. G. Tsantrizos, M. G. Drouet and A. Alexakis, “Plasma Gasification and Vitrification of Ashes, U.S. Pat. No. 5,958,264, Sep. 28, 1999
[5] C. H. Titus, D. R. Cohn and J. E. Surma, “Arc Plasma-Melter Electro Conversion System for Waste Treatment and Resource Recovery”, U.S. Patent No. 5,666,891, Sep. 16, 1997

1. A furnace for the gasification of waste which is entirely closed and sealed to control the gasification environment.

2. A furnace that is entirely air cooled, so as to avoid any risk of water leaks and steam explosions resulting from water cooling circuit failures.

3. An electrical circuit which allows the furnace to be operated in both non-transferred and transferred arc mode of operation and allowing to switch between non-transferred and transferred mode.

4. An operating method to restart the arc in case of process upsets.

5. A plasma arc furnace, comprising a spool and a crucible, a pair of movable electrodes, e.g. made of graphite, an air-cooled bottom electrode adapted for transferring current all through a slag melt, the furnace being sealed at a junction of the spool and the crucible thereof, and being further provided with gas tight electrode seals adapted to control reducing conditions inside the furnace.

6. The plasma arc furnace of claim 5, wherein an electrical circuit is provided, the electrical circuit being adapted for switching from transferred to non-transferred mode of heating, thereby allowing for the restarting of the furnace in case of slag freezing.

7. A DC arc furnace, comprising a spool and a crucible, a pair of movable electrodes, e.g. made of graphite, an air-cooled bottom electrode adapted for transferring current all through a slag melt, the furnace being sealed at a junction of the spool and the crucible thereof, and being further provided with gas tight electrode seals adapted to control reducing conditions inside the furnace.

8. The DC arc furnace of claim 7, wherein the spool and the crucible are both refractory-lined so as to operate at high temperatures; a refractory used in the crucible being, for instance, compatible with molten silicates type materials and can be typically made of high alumina or alumina chrome material; a refractory used in the spool being, for instance, compatible with potentially corrosive high temperature gases and can be typically made of a high alumina or alumina-silica material.

9. The DC arc furnace of any one of claims 7 and 8, wherein the material to be gasified and melted is introduced in the furnace, typically continuously, through at least one feed port located at the top of the spool.

10. The DC arc furnace of any one of claims 7 to 9, wherein the material being treated is adapted to accumulate in the crucible, creating a top layer thereat of partially treated waste.

11. The DC arc furnace of any one of claims 7 to 10, wherein high temperatures in the crucible, typically of more than 1400° C., and an injection of gasification air, oxygen and/or steam separate the organic from the inorganic fraction of the waste, wherein an inorganic fraction melts into a liquid slag layer floating on top of a molten metal layer; and wherein an organic fraction is converted into a synthesis gas consisting mainly of carbon monoxide and hydrogen or a combustion consisting mainly of carbon dioxide and water vapour, the synthesis gas being adapted to exit the furnace through an exhaust port.

12. The DC arc furnace of any one of claims 7 to 11, wherein an outside shell of the crucible is fitted with fins and forced air cooling, the forced air cooling being adapted to cause the slag freeze line to move well inside the layer of the liquid slag layer 5 and away from the refractory lining.

13. The DC arc furnace of any one of claims 7 to 12, wherein a pair of electric arcs are maintained inside the furnace, and are partially submerged in a mass of partially treated waste and are transferred to the liquid slag layer, the current passing through the molten metal layer and the bottom anode.

14. The DC arc furnace of any one of claims 7 to 13, wherein a pair of power supplies are adapted to provide the electric current to sustain the electric arcs, the power supplies being direct current (DC) units, e.g. of the current-controlled type; wherein the current is fed to the pair of electrodes, which are typically made of graphite.

15. The DC arc furnace of any one of claims 7 to 14, wherein current is fed to the two electrodes using a pair of electrode clamps.

16. The DC arc furnace of any one of claims 7 to 15, wherein the electrodes include connecting pins, typically threaded connectors, to allow two lengths of electrodes to be connected together, whereby once a length of electrode has been eroded, a new length can be screwed in from the outside of the furnace, using the aforementioned connecting pins.

17. The DC arc furnace of any one of claims 7 to 16, wherein the electrodes are mounted on respective movement mechanisms, which are adapted to slowly move the electrodes down in the furnace F as the electrodes are gradually eroded by the arcs.

18. The DC arc furnace of claims 17, wherein the movement mechanisms provide an up/down feature that also permits the adjustment of the arc voltage.

19. The DC arc furnace of any one of claims 7 to 18, wherein in order to adjust the plasma power, the voltage is maintained constant by adjusting the height of the electrodes; wherein a current set point is given to the power supplies which are provided with current controls; wherein the temperature of the liquid slag layer is adapted to be controlled by adjusting the plasma power; and wherein the plasma power is adapted to be used to compensate for energy requirements of endothermic reactions, such as pyrolysis reactions.

20. The DC arc furnace of any one of claims 7 to 19, wherein the spool and the crucible are made of two distinct parts, wherein the crucible is adapted to be detached from the spool.

21. The DC arc furnace of claim 20, wherein the crucible is provided with wheels and is adapted to be lowered onto a track and to be raised back into position using, for instance, a series of tie rods; with a series of nuts on each tie rod 18 being typically used to lift and maintain the crucible in place.

22. The DC arc furnace of any one of claims 7 to 21, wherein a pair of upper and lower tap holes are provided to extract respectively excess oxidized slag and liquid metal from the respective liquid slag layer and molten metal layer of the furnace.

23. The DC arc furnace of any one of claims 7 to 22, wherein the furnace is substantially completely enclosed, to prevent any unwanted ingression of air into the furnace; wherein a seal is provided between the spool and the crucible, this seal being made for instance of graphite or high temperature refractory paper.

24. The DC arc furnace of any one of claims 7 to 23, wherein there are provided an electrode seal around each of the two electrodes, and exteriorly of the spool.

25. The DC arc furnace of claim 24, wherein each electrode extends through an outer tube, which is fixed to a refractory of the spool, for instance via threaded rods that are cast in the refractory and nuts, which are used to hold the tube in place.

26. The DC arc furnace of claim 25, wherein layers of graphite rope provided on top of a refractory rope are used to seal the gap between the outer tube and the electrode.

27. The DC arc furnace of any one of claims 25 to 26, wherein a mobile tube is provided atop the layers of graphite rope and is adapted to be lowered thereon, using for instance a set of threaded rod, nuts and washers, whereby as the seal gets eroded from the movement of the electrode, the seal can be tightened around the electrode by lowering the mobile tube against the layers of graphite rope.

28. The DC arc furnace of any one of claims 7 to 27, wherein the bottom anode provides a current return path for the electricity used to power the electric arcs; wherein the bottom anode is air cooled, to avoid any risk of contact between the liquid slag and water in case of crucible failure and thereby to prevent steam explosions.

29. The DC arc furnace of any one of claims 7 to 28, wherein the bottom anode is provided with one or more electrodes which are conductive rods made typically of metal or graphite that is embedded in the refractory lining of the crucible; wherein the conductive rods are for instance either in direct contact with the liquid slag layer or in contact with a conductive plate, the conductive plate being made for instance of graphite or a metal such as iron or steel.

30. The DC arc furnace of claim 29, wherein as the metal plate will normally melt during furnace operation, the electrodes of the bottom anode are externally cooled using for instance cooling fins in order to avoid melting of the electrodes.

31. The DC arc furnace of any one of claims 29 to 30, wherein the conductive rods are connected, typically threadably, to copper rods in an aligned relationship; wherein shoulders are typically defined on the conductive rods to ensure a good electrical contact between the conductive rods.

32. The DC arc furnace of claim 31, wherein the copper rods are connected together with a copper plate 34, which copper plate 34 is held to the crucible by a tee-shaped metallic support, embedded in the refractory of the crucible.

33. The DC arc furnace of any one of claims 31 to 32, wherein the copper rods are connected in parallel, and the copper plate is connected to electrical DC cables through lugs; and wherein the cooling fins are made of copper or aluminum to maximize the heat transfer surface to the copper rods.

34. The DC arc furnace of any one of claims 30 to 33, wherein forced air cooling is used to cool the cooling fins, a plenum being provided to force air circulation around the cooling fins.

35. The DC arc furnace of claim 34, wherein a low-pressure air blower is provide to feed the cooling air to the plenum; wherein the plenum is typically held to the bottom of the crucible by a set of bolts that are threaded into the crucible shell; and wherein the plenum is for instance provided with baffles for better air distribution to the cooling fins.
